(19) United States
(12) Patent Application Publication
(10) Pub. No.: US 2008/0052272 A1
(43) Pub. Date: Feb. 28, 2008

(54) Method, System and Computer Program Product for Profile-Based Document Checking

(75) Inventors: Faheem Altaf, Pflugerville, TX (US); Dharmesh Bhakta, Austin, TX (US); Kumar Ravi, Cedar Park, TX (US); Radhakrishnan Sethuraman, Austin, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, ARMONK, NY (US)

(21) Appl. No.: 11/467,578

(22) Filed: Aug. 28, 2006

(51) Int. Cl. G06F 17/30

(52) U.S. Cl. 707/3

(57) ABSTRACT

A method for content checking a document, the method including: if the document is a word processing document then: determining if a profile category has been associated with the word processing document; if a profile category has not been associated with the word processing document, applying a default profile rule to perform the content checking; if a profile category has been associated with the word processing document, accessing a user-defined profile rule and applying the user-defined profile rule to perform the content checking; if the document is an email then: determining a profile category for each recipient of the email; determining a profile rule associated with each recipient of the email in response to the profile category; selecting one of the profile rules based on a rank of the profile rules; applying the selected profile rule to perform the content checking of the email.

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to checking documents, and more particularly, to checking text of a document based on a profile assigned or detected for the document.

2. Description of Background

Text in documents (e.g., emails, word processor documents, spreadsheets, presentations) can be automatically checked for content by spell checking or grammar checking routines. Spelling/Grammar checkers in productivity and e-mail applications treat all the documents alike. For example, when one writes an email to their colleagues and/or business clients, it would be beneficial to have Spell/Grammar checker utility to verify grammars, abbreviations and spellings to have a formal document. But, when writing emails to friends and/or family, one does not have to be formal. Treating all documents alike causes some inconvenience to the author of the document. For instance, it is okay to use abbreviation like “c ya 18r” or to have incorrect grammars when writing to your friends and family. Also, a scientific document will contain large number of abbreviations that will get spotted by the spell checker as a mistake. This is annoying to the user eventually causing them to turn-off the spell checker completely.

### SUMMARY OF THE INVENTION

The shortcomings of the prior art are overcome and additional advantages are provided through the provision of a method for content checking a document, the method comprising: if the document is a word processing document then: determining if a profile category has been associated with the word processing document; if a profile category has not been associated with the word processing document, applying a default profile rule to perform the content checking; if a profile category has been associated with the word processing document, accessing a user-defined profile rule and applying the user-defined profile rule to perform the content checking; if the document is an email then: determining a profile category for each recipient of the email; determining a profile rule associated with each recipient of the email in response to the profile category; selecting one of the profile rules based on a rank of the profile rules; applying the selected profile rule to perform the content checking of the email.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which enables checking of text in a document based on a document profile assigned to the document or a detected document profile.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary system for profile-based checking of documents, and

FIG. 2 illustrates an exemplary process for profile-based checking of documents.

The detailed description explains the preferred embodiments of the invention, together with advantages and features, by way of example with reference to the drawings.

### DETAILED DESCRIPTION OF THE INVENTION

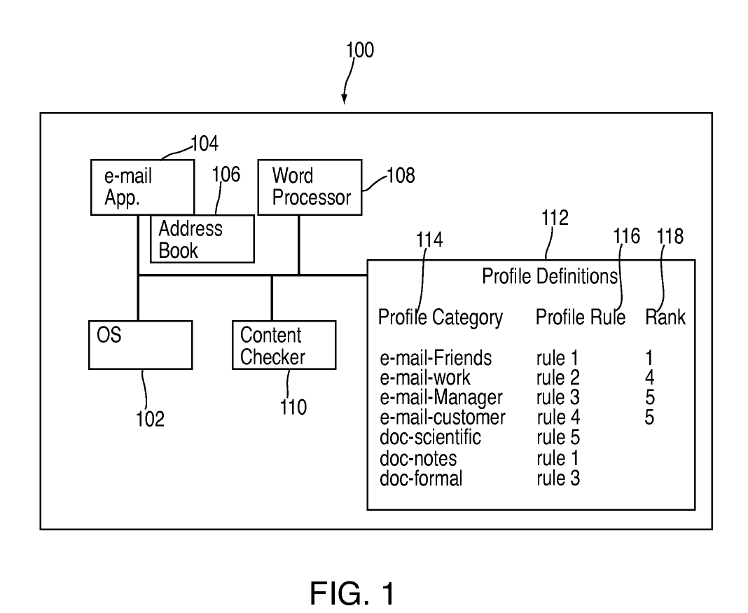

FIG. 1 illustrates a computer system 100 in which embodiments of the invention may be implemented. The computer system 100 may be a general-purpose computer as known in the art, executing software applications stored in computer program code to implement the processes described herein. The computer system 100 includes an operating system 102. An email application 104 provides for sending/receiving emails as known in the art. An address book 106 is associated with the email application 104 and stores contact information for sending emails. As described in further detail herein the address book 106 further includes profile categories that may be assigned to individual email addresses or email groups. The profile category is used to determine a profile rule to be used in checking content of the email.

A word processor application 108 provides for generation of documents as known in the art. A content checker application 110 performs content checking of text in emails or word processor documents. It is understood that the content checker 110 may actually be a component of the email application 104 and also be a separate component of the word processor 108. Thus, the content checker 110 may not be a stand-alone application, but is shown separate for ease of illustration.

Profile definitions 112 are stored in a memory accessible by the various applications. The profile definitions include a profile category 114 and an associated profile rule 116. Each profile category 114 is associated with a profile rule 116, although two categories may be associated with the same rule. For example, as shown in FIG. 1, an email to a manager is processed by the same rule as a formal document. The user can define the profile rules 116 by selecting or deselecting items to check (e.g., capitalization, punctuation, grammar, passive voice). For example, in a formal document, the user may wish all applicable spelling and grammar rules applied. By contrast, if the document is scratch notes, the user disables all spelling and grammar checking, as such features are not needed. Thus, the profile rules 116 are user-defined.

Further, email profile rules include a rank 118 that indicates how formal or strict the profile rule is when checking content. For example, an email to friends is typically informal, and the profile rule1 for emails to friends is ranked 1. This indicates that few spelling and grammar rules are applied. By contrast, profile rule3 for emails to managers is ranked 5, as the content checking for such emails is stricter and involves more spelling and grammar checks. Thus, the rank of the profile rule indicates the level of content checking applied by the profile rule.

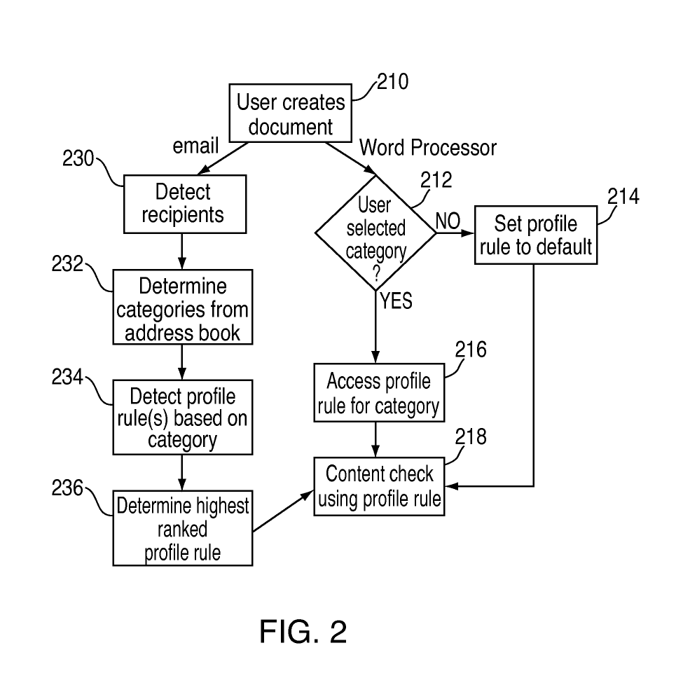

Exemplary operation of the system is illustrated in FIG. 2. The processing begins at step 210 when a user creates a document. As used herein, document refers to a variety of items including text, such as emails, word processing documents, presentations, etc. In FIG. 2, examples of processing of an email and a word processing document are provided. It is understood that processing will be similar regardless of the source of the document.

If the user has created a word processor document, flow proceeds to step 212 where it is determined if the user has identified a category for the document. A user may assign a category to a document through the word processor 108. For example, a menu may allow the user to identify the document as scientific, notes, formal, resume, etc. If the user has not selected a category for the document, flow proceeds to step 214 where a default profile rule is accessed by content checker 110 to perform content checking such as spell checking and grammar checking. Once the default profile rule for the word processor has been identified, flow proceeds to step 218 where the content checker checks the document using the identified profile rule.

If the user has identified a category for the document, flow proceeds to step 216 where the profile definitions 112 are accessed. The document category assigned by the user is compared to profile categories 114. Once a match is found, the profile rule 116 associated with the profile category 114 is accessed and provided to the content checker 110. For example, if the document category is formal, then the content checker 110 uses profile rule3 when performing the content check (e.g., spelling/grammar). Once the appropriate profile rule 116 is accessed, the content checker 110 performs the content check at step 218 using known techniques and applying the user-defined profile rule 116.

If at step 210 the user creates an email, flow proceeds to step 230 where the recipients of the e-mail are detected. The recipients may be individual email addresses or email group addresses. It should be noted that forwarding a received email is considered creating a new email, as an email may be forwarded from a more formal source to a less formal recipient. When forwarding an email, the sender may insert comments that need not be formal. Thus, a forwarded email is considered equivalent to creating a new email.

At step 232, categories for the email recipients are retrieved from the address book 106. The email application 104 provides the user with the ability to associate a category with an entry in the address book 106. For example, a drop down menu may be provided when viewing a contact which allows the user to select one or more categories for an individual contact or an email group. Further, as entries are added to the address book, the recipient may be associated with a default category, which may be overridden by the user.

Once the categories for the recipients have been identified from the address book 106, flow proceeds to step 234 where the email recipient categories are compared to the profile categories 114. For each email recipient, a profile rule is determined based on whether a match is found in the profile categories 114. If no match is found in the profile category 114 for an email recipient, then that recipient is associated with a default profile rule for the email application. For example, the contact information for John Doe in address book 106 indicates that John Doe is a friend, which results in profile rule1 being applied to the content of an email to John Doe.

Some profiles rules will be stricter and check content for a higher number of spelling and grammar issues (e.g., emails to managers). Other profile rules check for far fewer spelling/grammar items (e.g., emails to friends). The profile rules can be described as being ranked, with the higher rank corresponding to more strict profile rules and the lower rank corresponding to less strict profile rules. Some recipients will be associated with high ranked profile rules (e.g., managers), some recipients are associated with lower ranked profile rules (e.g., friends) while the default profile rule may have an intermediate rank.

Once the recipients of the email have been associated with a profile rule (either specific or default), the highest ranked profile rule associated with an email recipient is determined at step 236. This ensures that the content checker 110 always meets the most strict profile rules for a series of recipients. For example, and email sent to a friend and a manager would result in the manager's profile rule being applied to the content checker 110. Further, an email to a friend and a contact associated with a default profile rule would result in the default profile rule being application by the content checker 110, as the default profile rule would be higher ranked (e.g., more strict) than the profile rule for friends.

Once the highest ranked profile rule 116 is determined for the recipients of the email, flow proceeds to step 218 where the highest ranked profile rule is applied by the content checker 110. The highest rank profile rule allows the content checker to meet the strictest requirements (e.g., correct an informal email forwarded to a more formal recipient).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for content checking a document, the method comprising:
if the document is a word processing document then:
determining if a profile category has been associated with the word processing document;
if a profile category has not been associated with the word processing document, applying a default profile rule to perform the content checking;
if a profile category has been associated with the word processing document, accessing a user-defined profile rule and applying the user-defined profile rule to perform the content checking;
if the document is an email then:
determining a profile category for each recipient of the email;
determining a profile rule associated with each recipient of the email in response to the profile category;
selecting one of the profile rules based on a rank of the profile rules;
applying the selected profile rule to perform the content checking of the email.

2. The method of claim 1 wherein:
determining the profile rule associated with each recipient of the email includes identifying a default profile rule for email recipients not associated with a profile category.

3. The method of claim 2 wherein:
the rank of the profile rules is determined in response to a level of content checking performed by the profile rule, a higher ranked profile rule implementing more content checking than a lower ranked profile rule.

4. The method of claim 3 wherein:
selecting one of the profile rules based on the rank of the profile rules includes selecting the profile rule having the highest rank.

5. The method of claim 1 wherein:
the email recipient is an individual.

6. The method of claim 1 wherein:
the email recipient is a group.

7. The method of claim 1 wherein:
the content checking is spell checking.

8. The method of claim 1 wherein:
the content checking is grammar checking.

9. The method of claim 1 wherein:
determining the profile category for each recipient of the email includes associating a default profile category to a recipient upon entry in an address book.
